(19) United States
(12) Patent Application Publication
(10) Pub. No.: US 2025/0138170 A1
(43) Pub. Date: May 1, 2025

(54) SYSTEMS AND METHODS FOR TESTING LIDAR SENSOR SYSTEMS

(71) Applicant: Aurora Operations, Inc., Pittsburgh, PA (US)

(72) Inventors: Andrew Steil Michaels, Pittsburgh, PA (US); Tsz Chun Wong, Pittsburgh, PA (US)

(73) Assignee: Aurora Operations, Inc., Pittsburgh, PA (US)

(21) Appl. No.: 18/883,809

(22) Filed: Sep. 12, 2024

Related U.S. Application Data
(63) Continuation of application No. 18/496,470, filed on Oct. 27, 2023.

(51) Int. Cl. G01S 7/497; G01S 7/481; G01S 17/931

(52) U.S. Cl. CPC G01S 7/497; G01S 7/4814; G01S 17/931

(57) ABSTRACT

A device testing circuit for a LIDAR sensor system of a vehicle includes a first splitter optically coupled to a first connection and to a first device, the first device configured to generate a first output signal in response to receiving a first optical signal from the first connection through the first splitter, and a second splitter optically coupled to a second connection and to a second device, the second device configured to generate a second output signal in response to receiving a second optical signal from the second connection through the second splitter. The first splitter and the second splitter are optically coupled to each other.

### CROSS-REFERENCE TO RELATED APPLICATIONS

The present application is a continuation of U.S. patent application Ser. No. 18/496,470, filed Oct. 27, 2023, the entire disclosure of which is incorporated herein by reference.

### BACKGROUND

Optical detection of range using lasers, often referenced by a mnemonic, LIDAR (for “light detection and ranging”), also sometimes referred to as “laser RADAR,” is used for a variety of applications, including imaging and collision avoidance. LIDAR provides finer scale range resolution with smaller beam sizes than conventional microwave ranging systems, such as radio-wave detection and ranging (RADAR).

### SUMMARY

At least one aspect relates to a device testing circuit for a LIDAR sensor system of a vehicle, including a first splitter optically coupled to a first connection and to a first device, the first device configured to generate a first output signal in response to receiving a first optical signal from the first connection through the first splitter; and a second splitter optically coupled to a second connection and to a second device, the second device configured to generate a second output signal in response to receiving a second optical signal from the second connection through the second splitter. The first splitter and the second splitter are optically coupled to each other.

At least one aspect relates to a system for testing devices for a LIDAR sensor system of a vehicle, including a test circuit. The test circuit includes a first splitter optically coupled to a first connection and to a first device, the first device configured to generate a first output signal in response to receiving a first optical signal from the first splitter; and a second splitter optically coupled to a second connection and to a second device, the second device configured to generate a second output signal in response to receiving a second optical signal from the second splitter. The first splitter and the second splitter are optically coupled to each other; and a test apparatus configured to communicate a signal with the test circuit through the first connection and the second connection.

At least one aspect relates to a LIDAR sensor system for a vehicle, including a laser source configured to output a source beam; a modulator configured to receive a modulation signal and modulate the source beam based on the modulation signal to produce a modulated beam; an amplifier configured to amplify the modulated beam; and a test circuit. The test circuit includes a first splitter optically coupled to a first device, the first device being at least one of the laser source, the modulator, or the amplifier; and a second splitter optically coupled to a second device and the first splitter. In response to receipt of a first input signal, the first splitter is configured to split the first input signal into a first optical signal to be directed to the first device and a first reference signal to be directed to the second splitter.

At least one aspect relates to a method for testing circuits for a LIDAR sensor system of a vehicle. The method includes generating a first output signal in response to receiving a first optical signal from a first connection through a first splitter; and generating a second output signal in response to receiving a second optical signal from a second connection through a second splitter. The first splitter and the second splitter are optically coupled to each other.

Those skilled in the art will appreciate that the summary is illustrative only and is not intended to be in any way limiting. Any of the features described herein may be used with any other features, and any subset of such features can be used in combination according to various embodiments. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

Implementations are illustrated by way of example, and not by way of limitation, in the figures of the accompanying drawings in which like reference numerals refer to similar elements and in which:

FIG. 1 is a block diagram illustrating an example of a system environment for autonomous vehicles according to some implementations;

FIG. 2 is a block diagram illustrating an example of a system environment for autonomous commercial trucking vehicles according to some implementations;

FIG. 3 is a block diagram illustrating an example of a system environment for autonomous commercial trucking vehicles according to some implementations;

FIG. 4 is a block diagram illustrating an example of a system environment for autonomous commercial trucking vehicles according to some implementations;

FIG. 5 is a block diagram illustrating an example of a LIDAR sensor system according to some implementations;

FIG. 6 is a block diagram illustrating an example system for testing devices for a LIDAR sensor system according to some implementations;

FIG. 7 is a schematic diagram illustrating an example test circuit in a first mode for testing devices for a LIDAR sensor system according to some implementations;

FIG. 8 is a schematic diagram illustrating an example test circuit in a second mode for testing devices for a LIDAR sensor system according to some implementations;

FIG. 9 is a schematic diagram illustrating an example system for testing devices for a LIDAR sensor system according to some implementations;

FIG. 10 is a schematic diagram illustrating an example test circuit for testing devices for a LIDAR sensor system according to some implementations; and

FIG. 11 is a flow diagram illustrating an example method for operating a test circuit according to some implementations.

### DETAILED DESCRIPTION

A LIDAR sensor system can generate and transmit a light beam that an object can reflect or otherwise scatter as a return beam corresponding to the transmitted beam. The LIDAR sensor system can receive the return beam, and process the return beam or characteristics thereof to determine parameters regarding the object such as range and velocity. The LIDAR sensor system can apply various frequency or phase modulations to the transmitted beam, which can facilitate relating the return beam to the transmitted beam in order to determine the parameters regarding the object.

The LIDAR sensor systems include a number of electro-optic components, including optical and/or optoelectronic devices (e.g., a photodetector, a free space optical coupler, etc.). It is useful to characterize and monitor such devices from manufacturing to operation stages for effective operation of the LIDAR sensor systems. Current testing approaches are prone to inaccuracies and uncertainty that stem from factors including optical coupling between components in the LIDAR sensor systems.

Techniques disclosed herein provide systems and methods for testing components of LIDAR sensor systems to characterize the same in a robust and scalable manner while mitigating or otherwise addressing uncertainty in optical coupling. The techniques disclosed herein can eliminate sources of inaccuracies while being compatible with wafer-level measurements thereby allowing for high-volume manufacturing. The techniques disclosed herein can be applied to devices (e.g., optoelectronic devices) that are needed in integrated LIDAR systems.

### System Environments for Autonomous Vehicles

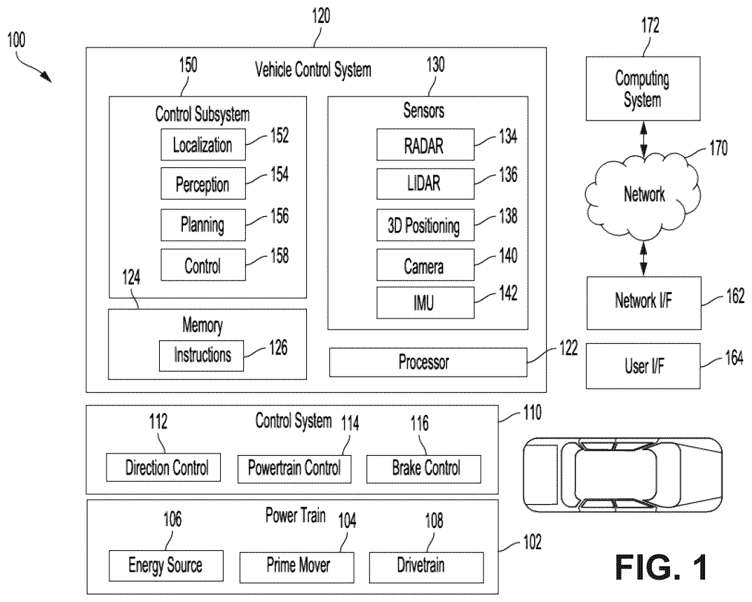

FIG. 1 is a block diagram illustrating an example of a system environment for autonomous vehicles according to some implementations. FIG. 1 depicts an example autonomous vehicle 100 within which the various techniques disclosed herein may be implemented. The vehicle 100, for example, may include a powertrain 102 including a prime mover 104 powered by an energy source 106 and capable of providing power to a drivetrain 108, as well as a control system 110 including a direction control 112, a powertrain control 114, and a brake control 116. The vehicle 100 may be implemented as any number of different types of vehicles, including vehicles capable of transporting people and/or cargo, and capable of traveling in various environments. The aforementioned components 102-116 can vary widely based upon the type of vehicle within which these components are utilized, such as a wheeled land vehicle such as a car, van, truck, or bus. The prime mover 104 may include one or more electric motors and/or an internal combustion engine (among others). The energy source may include, for example, a fuel system (e.g., providing gasoline, diesel, hydrogen, etc.), a battery system, solar panels or other renewable energy source, and/or a fuel cell system. The drivetrain 108 can include wheels and/or tires along with a transmission and/or any other mechanical drive components to convert the output of the prime mover 104 into vehicular motion, as well as one or more brakes configured to controllably stop or slow the vehicle 100 and direction or steering components suitable for controlling the trajectory of the vehicle 100 (e.g., a rack and pinion steering linkage enabling one or more wheels of the vehicle 100 to pivot about a generally vertical axis to vary an angle of the rotational planes of the wheels relative to the longitudinal axis of the vehicle). In some implementations, combinations of powertrains and energy sources may be used (e.g., in the case of electric/gas hybrid vehicles), and in some instances multiple electric motors (e.g., dedicated to individual wheels or axles) may be used as a prime mover.

The direction control 112 may include one or more actuators and/or sensors for controlling and receiving feedback from the direction or steering components to enable the vehicle 100 to follow a desired trajectory. The powertrain control 114 may be configured to control the output of the powertrain 102, e.g., to control the output power of the prime mover 104, to control a gear of a transmission in the drivetrain 108, etc., thereby controlling a speed and/or direction of the vehicle 100. The brake control 116 may be configured to control one or more brakes that slow or stop vehicle 100, e.g., disk or drum brakes coupled to the wheels of the vehicle.

Other vehicle types, including but not limited to off-road vehicles, all-terrain or tracked vehicles, construction equipment, may utilize different powertrains, drivetrains, energy sources, direction controls, powertrain controls and brake controls. Moreover, in some implementations, some of the components can be combined, e.g., where directional control of a vehicle is primarily handled by varying an output of one or more prime movers.

Various levels of autonomous control over the vehicle 100 can be implemented in a vehicle control system 120, which may include one or more processors 122 and one or more memories 124, with each processor 122 configured to execute program code instructions 126 stored in a memory 124. The processor(s) can include, for example, graphics processing unit(s) (“GPU(s)”)) and/or central processing unit(s) (“CPU(s)”).

Sensors 130 may include various sensors suitable for collecting information from a vehicle's surrounding environment for use in controlling the operation of the vehicle. For example, sensors 130 can include radar sensor 134, LIDAR (Light Detection and Ranging) sensor 136, a 3D positioning sensors 138, e.g., any of an accelerometer, a gyroscope, a magnetometer, or a satellite navigation system such as GPS (Global Positioning System), GLONASS (Globalnaya Navigazionnaya Sputnikovaya Sistema, or Global Navigation Satellite System), BeiDou Navigation Satellite System (BDS), Galileo, Compass, etc. The 3D positioning sensors 138 can be used to determine the location of the vehicle on the Earth using satellite signals. The sensors 130 can include a camera 140 and/or an IMU (inertial measurement unit) 142. The camera 140 can be a monographic or stereographic camera and can record still and/or video images. The IMU 142 can include multiple gyroscopes and accelerometers capable of detecting linear and rotational motion of the vehicle in three directions. One or more encoders (not illustrated), such as wheel encoders may be used to monitor the rotation of one or more wheels of vehicle 100. Each sensor 130 can output sensor data at various data rates, which may be different than the data rates of other sensors 130.

The outputs of sensors 130 may be provided to a set of control subsystems 150, including a localization subsystem 152, a planning subsystem 156, a perception subsystem 154, and a control subsystem 158. The localization subsystem 152 can perform functions such as precisely determining the location and orientation (also sometimes referred to as “pose”) of the vehicle 100 within its surrounding environment, and generally within some frame of reference. The location of an autonomous vehicle can be compared with the location of an additional vehicle in the same environment as part of generating labeled autonomous vehicle data. The perception subsystem 154 can perform functions such as detecting, tracking, determining, and/or identifying objects within the environment surrounding vehicle 100. A machine learning model in accordance with some implementations can be utilized in tracking objects. The planning subsystem 156 can perform functions such as planning a trajectory for vehicle 100 over some timeframe given a desired destination as well as the static and moving objects within the environment. A machine learning model in accordance with some implementations can be utilized in planning a vehicle trajectory. The control subsystem 158 can perform functions such as generating suitable control signals for controlling the various controls in the vehicle control system 120 in order to implement the planned trajectory of the vehicle 100. A machine learning model can be utilized to generate one or more signals to control an autonomous vehicle to implement the planned trajectory.

Multiple sensors of types illustrated in FIG. 1 can be used for redundancy and/or to cover different regions around a vehicle, and other types of sensors may be used. Various types and/or combinations of control subsystems may be used. Some or all of the functionality of a subsystem 152-158 may be implemented with program code instructions 126 resident in one or more memories 124 and executed by one or more processors 122, and these subsystems 152-158 may in some instances be implemented using the same processor(s) and/or memory. Subsystems may be implemented at least in part using various dedicated circuit logic, various processors, various field programmable gate arrays (“FPGA”), various application-specific integrated circuits (“ASIC”), various real time controllers, and the like, as noted above, multiple subsystems may utilize circuitry, processors, sensors, and/or other components. Further, the various components in the vehicle control system 120 may be networked in various manners.

In some implementations, the vehicle 100 may also include a secondary vehicle control system (not illustrated), which may be used as a redundant or backup control system for the vehicle 100. In some implementations, the secondary vehicle control system may be capable of fully operating the autonomous vehicle 100 in the event of an adverse event in the vehicle control system 120, while in other implementations, the secondary vehicle control system may only have limited functionality, e.g., to perform a controlled stop of the vehicle 100 in response to an adverse event detected in the primary vehicle control system 120. In still other implementations, the secondary vehicle control system may be omitted.

Various architectures, including various combinations of software, hardware, circuit logic, sensors, and networks, may be used to implement the various components illustrated in FIG. 1. Each processor may be implemented, for example, as a microprocessor and each memory may represent the random access memory (“RAM”) devices comprising a main storage, as well as any supplemental levels of memory, e.g., cache memories, non-volatile or backup memories (e.g., programmable or flash memories), read-only memories, etc. In addition, each memory may be considered to include memory storage physically located elsewhere in the vehicle 100, e.g., any cache memory in a processor, as well as any storage capacity used as a virtual memory, e.g., as stored on a mass storage device or another computer controller. One or more processors illustrated in FIG. 1, or entirely separate processors, may be used to implement additional functionality in the vehicle 100 outside of the purposes of autonomous control, e.g., to control entertainment systems, to operate doors, lights, convenience features, etc.

In addition, for additional storage, the vehicle 100 may include one or more mass storage devices, e.g., a removable disk drive, a hard disk drive, a direct access storage device (“DASD”), an optical drive (e.g., a CD drive, a DVD drive, etc.), a solid state storage drive (“SSD”), network attached storage, a storage area network, and/or a tape drive, among others.

Furthermore, the vehicle 100 may include a user interface 164 to enable vehicle 100 to receive a number of inputs from and generate outputs for a user or operator, e.g., one or more displays, touchscreens, voice and/or gesture interfaces, buttons and other tactile controls, etc. Otherwise, user input may be received through (e.g., by way of) another computer or electronic device, e.g., through an app on a mobile device or through a web interface.

Moreover, the vehicle 100 may include one or more network interfaces, e.g., network interface 162, suitable for communicating with one or more networks 170 (e.g., a Local Area Network (“LAN”), a wide area network (“WAN”), a wireless network, and/or the Internet, among others) to permit the communication of information with other computers and electronic device, including, for example, a central service, such as a cloud service, from which the vehicle 100 receives environmental and other data for use in autonomous control thereof. Data collected by the one or more sensors 130 can be uploaded to a computing system 172 through the network 170 for additional processing. In some implementations, a time stamp can be added to each instance of vehicle data prior to uploading.

Each processor illustrated in FIG. 1, as well as various additional controllers and subsystems disclosed herein, generally operates under the control of an operating system and executes or otherwise relies upon various computer software applications, components, programs, objects, modules, data structures, etc., as will be described in greater detail below. Moreover, various applications, components, programs, objects, modules, etc. may also execute on one or more processors in another computer coupled to vehicle 100 through network 170, e.g., in a distributed, cloud-based, or client-server computing environment, whereby the processing required to implement the functions of a computer program may be allocated to multiple computers and/or services over a network.

In general, the routines executed to implement the various implementations described herein, whether implemented as part of an operating system or a specific application, component, program, object, module or sequence of instructions, or even a subset thereof, will be referred to herein as “program code”. Program code can include one or more instructions that are resident at various times in various memory and storage devices, and that, when read and executed by one or more processors, perform the steps necessary to execute steps or elements embodying the various aspects of the present disclosure. Moreover, while implementations have and hereinafter will be described in the context of fully functioning computers and systems, it will be appreciated that the various implementations described herein are capable of being distributed as a program product in a variety of forms, and that implementations can be implemented regardless of the particular type of computer readable media used to actually carry out the distribution.

Examples of computer readable media include tangible, non-transitory media such as volatile and non-volatile memory devices, floppy and other removable disks, solid state drives, hard disk drives, magnetic tape, and optical disks (e.g., CD-ROMs, DVDs, etc.) among others.

In addition, various program code described hereinafter may be identified based upon the application within which it is implemented in a specific implementation. Any particular program nomenclature that follows is used merely for convenience, and thus the present disclosure should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), the present disclosure is not limited to the specific organization and allocation of program functionality described herein.

### 1. LIDAR for Automotive Applications

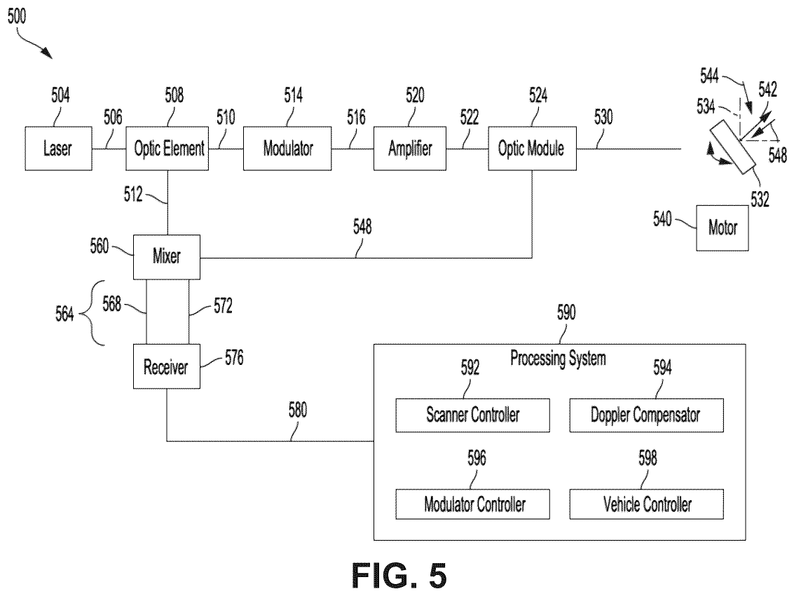

A truck can include a LIDAR system (e.g., vehicle control system 120 in FIG. 1, LIDAR sensor system 500 in FIG. 5, among others described herein). In some implementations, the LIDAR sensor system 500 can use frequency modulation to encode an optical signal and scatter the encoded optical signal into free-space using optics. By detecting the frequency differences between the encoded optical signal and a returned signal reflected back from an object, the frequency modulated (FM) LIDAR sensor system can determine the location of the object and/or precisely measure the velocity of the object using the Doppler effect. In some implementations, an FM LIDAR sensor system may use a continuous wave (referred to as, “FMCW LIDAR”) or a quasi-continuous wave (referred to as, “FMQW LIDAR”). In some implementations, the LIDAR sensor system can use phase modulation (PM) to encode an optical signal and scatters the encoded optical signal into free-space using optics.

In some instances, an object (e.g., a pedestrian wearing dark clothing) may have a low reflectivity, in that it only reflects back to the sensors (e.g., sensors 130 in FIG. 1) of the FM or PM LIDAR sensor system a low amount (e.g., 10% or less) of the light that hit the object. In other instances, an object (e.g., a shiny road sign) may have a high reflectivity (e.g., above 10%), in that it reflects back to the sensors of the FM LIDAR sensor system a high amount of the light that hit the object.

Regardless of the object's reflectivity, an FM LIDAR sensor system may be able to detect (e.g., classify, recognize, discover, etc.) the object at greater distances (e.g., 2×) than a conventional LIDAR sensor system. For example, an FM LIDAR sensor system may detect a low reflectivity object beyond 300 meters, and a high reflectivity object beyond 400 meters.

To achieve such improvements in detection capability, the FM LIDAR sensor system may use sensors (e.g., sensors 130 in FIG. 1). In some implementations, these sensors can be single photon sensitive, meaning that they can detect the smallest amount of light possible. While an FM LIDAR sensor system may, in some applications, use infrared wavelengths (e.g., 950 nm, 1550 nm, etc.), it is not limited to the infrared wavelength range (e.g., near infrared: 800 nm-1500 nm; middle infrared: 1500 nm-5602 nm; and far infrared: 5602 nm-1,000,000 nm). By operating the FM or PM LIDAR sensor system in infrared wavelengths, the FM or PM LIDAR sensor system can broadcast stronger light pulses or light beams than conventional LIDAR sensor systems.

Thus, by detecting an object at greater distances, an FM LIDAR sensor system may have more time to react to unexpected obstacles. Indeed, even a few milliseconds of extra time could improve response time and comfort, especially with heavy vehicles (e.g., commercial trucking vehicles) that are driving at highway speeds.

The FM LIDAR sensor system can provide accurate velocity for each data point instantaneously. In some implementations, a velocity measurement is accomplished using the Doppler effect which shifts frequency of the light received from the object based at least one of the velocity in the radial direction (e.g., the direction vector between the object detected and the sensor) or the frequency of the laser signal. For example, for velocities encountered in on-road situations where the velocity is less than 100 meters per second (m/s), this shift at a wavelength of 1550 nanometers (nm) amounts to the frequency shift that is less than 130 megahertz (MHz). This frequency shift is small such that it is difficult to detect directly in the optical domain. However, by using coherent detection in FMCW, PMCW, or FMQW LIDAR sensor systems, the signal can be converted to the RF domain such that the frequency shift can be calculated using various signal processing techniques. This enables the autonomous vehicle control system to process incoming data faster.

Instantaneous velocity calculation also makes it easier for the FM LIDAR sensor system to determine distant or sparse data points as objects and/or track how those objects are moving over time. For example, an FM LIDAR sensor (e.g., sensors 130 in FIG. 1) may only receive a few returns (e.g., hits) on an object that is 300 m away, but if those return give a velocity value of interest (e.g., moving towards the vehicle at >70 mph), then the FM LIDAR sensor system and/or the autonomous vehicle control system may determine respective weights to probabilities associated with the objects.

Faster identification and/or tracking of the FM LIDAR sensor system gives an autonomous vehicle control system more time to maneuver a vehicle. A better understanding of how fast objects are moving also allows the autonomous vehicle control system to plan a better reaction.

The FM LIDAR sensor system can have less static compared to conventional LIDAR sensor systems. That is, the conventional LIDAR sensor systems that are designed to be more light-sensitive typically perform poorly in bright sunlight. These systems also tend to suffer from crosstalk (e.g., when sensors get confused by each other's light pulses or light beams) and from self-interference (e.g., when a sensor gets confused by its own previous light pulse or light beam). To overcome these disadvantages, vehicles using the conventional LIDAR sensor systems often need extra hardware, complex software, and/or more computational power to manage this “noise.”

In contrast, FM LIDAR sensor systems do not suffer from these types of issues because each sensor is specially designed to respond only to its own light characteristics (e.g., light beams, light waves, light pulses). If the returning light does not match the timing, frequency, and/or wavelength of what was originally transmitted, then the FM sensor can filter (e.g., remove, ignore, etc.) out that data point. As such, FM LIDAR sensor systems produce (e.g., generates, derives, etc.) more accurate data with less hardware or software requirements, enabling smoother driving.

The FM LIDAR sensor system can be easier to scale than conventional LIDAR sensor systems. As more self-driving vehicles (e.g., cars, commercial trucks, etc.) show up on the road, those powered by an FM LIDAR sensor system likely will not have to contend with interference issues from sensor crosstalk. Furthermore, an FM LIDAR sensor system uses less optical peak power than conventional LIDAR sensors. As such, some or all of the optical components for an FM LIDAR can be produced on a single chip, which produces its own benefits, as discussed herein.

### 1.1 Commercial Trucking

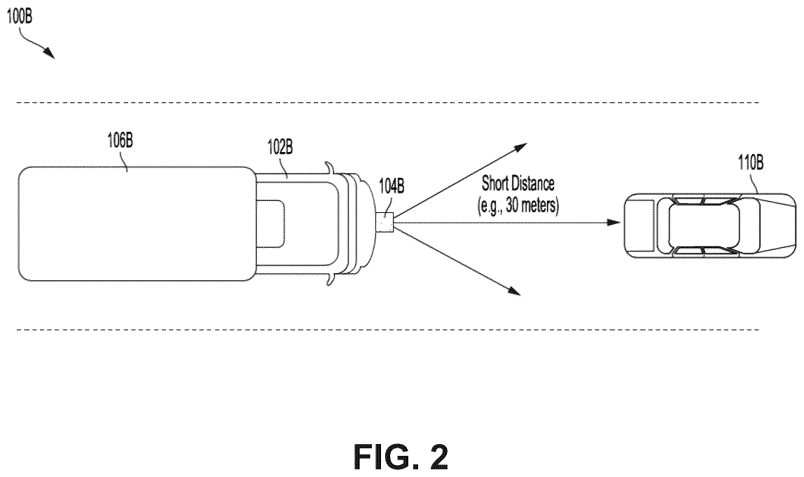

FIG. 2 is a block diagram illustrating an example of a system environment for autonomous commercial trucking vehicles, according to some implementations. The environment 100B includes a commercial truck 102B for hauling cargo 106B. In some implementations, the commercial truck 102B may include vehicles configured to long-haul freight transport, regional freight transport, intermodal freight transport (i.e., in which a road-based vehicle is used as one of multiple modes of transportation to move freight), and/or any other road-based freight transport applications. In some implementations, the commercial truck 102B may be a flatbed truck, a refrigerated truck (e.g., a reefer truck), a vented van (e.g., dry van), a moving truck, etc. In some implementations, the cargo 106B may be goods and/or products. In some implementations, the commercial truck 102B may include a trailer to carry the cargo 106B, such as a flatbed trailer, a lowboy trailer, a step deck trailer, an extendable flatbed trailer, a sidekit trailer, etc.

The environment 100B includes an object 110B (shown in FIG. 2 as another vehicle) that is within a distance range that is equal to or less than 30 meters from the truck.

The commercial truck 102B may include a LIDAR sensor system 104B (e.g., an FM LIDAR sensor system, vehicle control system 120 in FIG. 1, LIDAR sensor system 500 in FIG. 5) for determining a distance to the object 110B and/or measuring the velocity of the object 110B. Although FIG. 2 shows that one LIDAR sensor system 104B is mounted on the front of the commercial truck 102B, the number of LIDAR sensor systems and the mounting area of the LIDAR sensor system on the commercial truck are not limited to a particular number or a particular area. The commercial truck 102B may include any number of LIDAR sensor systems 104B (or components thereof, such as sensors, modulators, coherent signal generators, etc.) that are mounted onto any area (e.g., front, back, side, top, bottom, underneath, and/or bottom) of the commercial truck 102B to facilitate the detection of an object in any free-space relative to the commercial truck 102B.

As shown, the LIDAR sensor system 104B in environment 100B may be configured to detect an object (e.g., another vehicle, a bicycle, a tree, street signs, potholes, etc.) at short distances (e.g., 30 meters or less) from the commercial truck 102B.

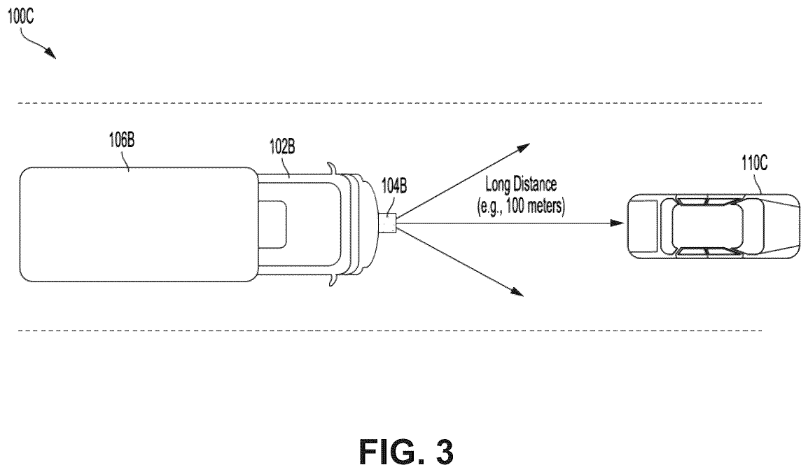

FIG. 3 is a block diagram illustrating an example of a system environment for autonomous commercial trucking vehicles, according to some implementations. The environment 100C includes the same components (e.g., commercial truck 102B, cargo 106B, LIDAR sensor system 104B, etc.) that are included in environment 100B.

The environment 100C includes an object 110C (shown in FIG. 3 as another vehicle) that is within a distance range that is (i) more than 30 meters and (ii) equal to or less than 150 meters from the commercial truck 102B. As shown, the LIDAR sensor system 104B in environment 100C may be configured to detect an object (e.g., another vehicle, a bicycle, a tree, street signs, potholes, etc.) at a distance (e.g., 100 meters) from the commercial truck 102B.

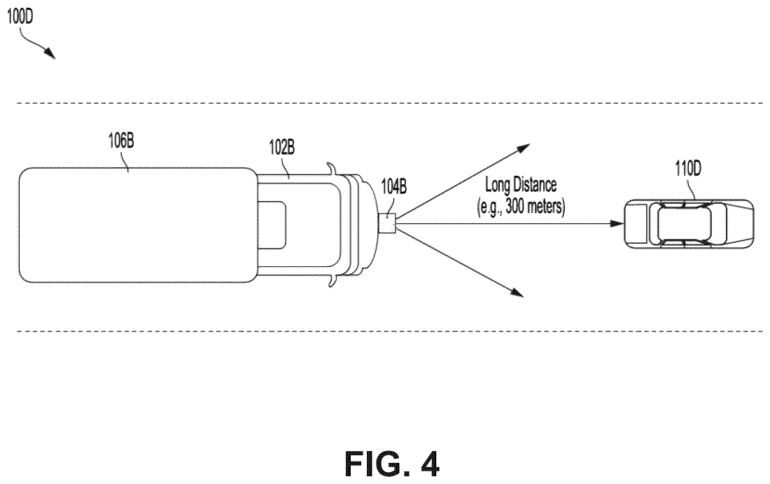

FIG. 4 is a block diagram illustrating an example of a system environment for autonomous commercial trucking vehicles, according to some implementations. The environment 100D includes the same components (e.g., commercial truck 102B, cargo 106B, LIDAR sensor system 104B, etc.) that are included in environment 100B.

The environment 100D includes an object 110D (shown in FIG. 4 as another vehicle) that is within a distance range that is more than 150 meters from the commercial truck 102B. As shown, the LIDAR sensor system 104B in environment 100D may be configured to detect an object (e.g., another vehicle, a bicycle, a tree, street signs, potholes, etc.) at a distance (e.g., 300 meters) from the commercial truck 102B.

In commercial trucking applications, it is important to effectively detect objects at all ranges due to the increased weight and, accordingly, longer stopping distance required for such vehicles. FM LIDAR sensor systems (e.g., FMCW and/or FMQW systems) or PM LIDAR sensor systems are well-suited for commercial trucking applications due to the advantages described above. As a result, commercial trucks equipped with such systems may have an enhanced ability to move both people and goods across short or long distances. In various implementations, such FM or PM LIDAR sensor systems can be used in semi-autonomous applications, in which the commercial truck has a driver and some functions of the commercial truck are autonomously operated using the FM or PM LIDAR sensor system, or fully autonomous applications, in which the commercial truck is operated entirely by the FM or LIDAR sensor system, alone or in combination with other vehicle systems.

### 2. LIDAR Sensor Systems

FIG. 5 is a block diagram illustrating an example of a LIDAR sensor system 500 according to some implementations. The LIDAR sensor system 500 can be used to determine parameters regarding objects, such as range and velocity, and output the parameters to a remote system. For example, the LIDAR sensor system 500 can output the parameters for use by a vehicle controller that can control operation of a vehicle responsive to the received parameters (e.g., vehicle controller 598) or a display that can present a representation of the parameters. The LIDAR sensor system 500 can be a coherent detection system. The LIDAR sensor system 500 can be used to implement various features and components of the systems described with reference to FIGS. 1-4. The LIDAR sensor system 500 can include components for performing various detection approaches, such as to be operated as an amplitude modular LIDAR system or a coherent LIDAR system. The LIDAR sensor system 500 can be used to perform time of flight range determination. In some implementations, various components or combinations of components of the LIDAR sensor system 500, such as laser source 504 and modulator 514, can be in the same housing, provided in the same circuit board or other electronic component, or otherwise integrated. In some implementations, various components or combinations of components of the LIDAR sensor system 500 can be provided as separate components, such as by using optical couplings (e.g., optical fibers) for components that generate and/or receive optical signals, such as light beams, or wired or wireless electronic connections for components that generate and/or receive electrical (e.g., data) signals. Various components of the LIDAR sensor system 500 can be arranged with respect to one another such that light (e.g., beams of light) between the components is directed through free space, such as a space provided by an air (or vacuum) gap, a space that is not through an optical fiber, a space that is free of structural components around a path along which the light is directed (e.g., an empty space at least on the order of millimeters away from a direct line path between the components; an empty space of a size greater than an expected beam width of the light, such as where the light is a collimated beam), or various combinations thereof.

In some implementations, a semiconductor substrate and/or semiconductor package include one or more components of at least one of a transmission (Tx) path or a receiving (Rx) path of the LIDAR sensor system 500. This can include, for example, optical and/or electronic components that can generate heat that may be transferred into the semiconductor substrate and/or semiconductor package during operation. In some implementations, the semiconductor substrate and/or semiconductor package include at least one of silicon photonics circuitry, planar lightwave circuitry (PLC), or III-V semiconductor circuitry.

In some implementations, the optical and/or electronic components formed on or coupled to the semiconductor substrate and/or semiconductor package to perform a plurality of functions in the LIDAR sensor system 500 are collectively referred to as a circuit module. In some implementations, the circuit module includes III-V semiconductor circuitry coupled to at least one of silicon photonics circuitry or PLC. In the present disclosure, “coupling” may refer to a physical connection, an electrical connection, or both, between two components.

In some implementations, a first semiconductor substrate and/or a first semiconductor package include the Tx path and a second semiconductor substrate and/or a second semiconductor package may include the Rx path. In some arrangements, the Rx input/output ports and/or the Tx input/output ports may occur (or be formed/disposed/located/placed) along one or more edges of one or more semiconductor substrates and/or semiconductor packages.

In some implementations, the circuit module includes at least one of silicon photonics circuitry, PLC, or III-V semiconductor circuitry in which all of its components (e.g., optical paths, optical amplifiers, phase modulators, etc.) are formed on, disposed over, or otherwise coupled to a single substrate. In some implementations, all of the components of the circuit module are formed on, disposed over, or otherwise coupled to a single layer to form a horizontal structure of an integrated circuit. In some implementations, components of the circuit module are formed on, disposed over, or otherwise coupled to multiple layers stacked on a single substrate to form a vertical structure of an integrated circuit. For example, the circuit module may include phase modulators implemented as one or more PLC modules, optical paths implemented as silicon photonics circuitry, and SOAs implemented as III-V modules, all of which are formed on, disposed over, or otherwise coupled to a single III-V substrate. The III-V semiconductor materials may include at least one of gallium arsenide (GaAs), indium phosphide (InP), indium arsenide (InAs), or combinations thereof.

The LIDAR sensor system 500 can include a laser source 504 that generates and emits a beam 506, such as a carrier wave light beam. An optic element 508 can split the beam 506 into a beam 510 (sometimes referred to as input beam) and a reference beam 512 (e.g., reference signal). In some implementations, any suitable optical, electronic, or optoelectronic elements are used to provide the beam 510 and the reference beam 512 from the laser source 504 to other elements. For example, the optic element 508 can be a splitter or a circulator.

A modulator 514 can modulate one or more properties of the input beam 510 to generate a beam 516 (e.g., target beam) and/or encode information on the input beam 510. In some implementations, the modulator 514 can modulate a frequency of the input beam 510 (e.g., optical frequency corresponding to optical wavelength, where c=λv, where c is the speed of light, λ is the wavelength, and v is the frequency). For example, the modulator 514 can modulate a frequency of the input beam 510 linearly such that a frequency of the beam 516 increases or decreases linearly over time. As another example, the modulator 514 can modulate a frequency of the input beam 510 non-linearly (e.g., exponentially). In some implementations, the modulator 514 can modulate a phase of the input beam 510 to generate the beam 516. However, the modulation techniques are not limited to the frequency modulation and the phase modulation. Any suitable modulation techniques can be used to modulate one or more properties of a beam. Returning to FIG. 5, the modulator 514 can modulate the beam 510 subsequent to splitting of the beam 506 by the optic element 508, such that the reference beam 512 is unmodulated, or the modulator 514 can modulate the beam 506 and provide a modulated beam to the optic element 508 for the optic element 508 to split into a target beam and a reference beam. In some implementations, the modulator 514 includes a circuit module having at least one of silicon photonics circuitry, PLC, or III-V semiconductor circuitry.

The beam 516, which is used for outputting a transmitted signal, can have most of the energy of the beam 506 outputted by the laser source 504, while the reference beam 512 can have significantly less energy, yet sufficient energy to enable mixing with a return beam 548 (e.g., returned light) scattered from an object. The reference beam 512 can be used as a local oscillator (LO) signal. The reference beam 512 passes through a reference path and can be provided to a mixer 560. An amplifier 520 can amplify the beam 516 to output a beam 522.

The LIDAR sensor system 500 can include an optic module 524, which can receive the beam 522. The optic module 524 can be a free space optic. For example, the optic module 524 can include one or more optics (e.g., lenses, mirrors, waveguides, grating couplers, prisms, waveplates) arranged to have a gap (e.g., air gap) between the one or more optics, allowing for free space transmission of light (e.g., rather than all light being coupled between optics by fibers). The optic module 524 can perform functions such as collimating, filtering, and/or polarizing the beam 522 to output a beam 530 to optics 532 (e.g., scanning optics).

In some implementations, the LIDAR sensor system 500 may include or be coupled with a test circuit and/or a test apparatus or at least a component thereof. For example, such a test circuit and/or a test apparatus can be optically coupled to at least one of the laser 504, the modulator 514, the amplifier 520, etc. and can characterize the coupled components. Techniques including the test circuit and the test apparatus will be discussed in greater detail below.

### 3. Systems and Methods for Testing LIDAR Sensor Systems

As disclosed herein, a test circuit can be used to test and characterize components of LIDAR sensor systems. The LIDAR sensor systems include a number of components, including optical and/or optoelectronic devices (e.g., a photodetector, a free space optical coupler, etc.). It is useful to characterize and/or monitor such components from manufacturing to operation stages for effective operation of the LIDAR sensor systems. Techniques disclosed herein provide systems and methods for testing (e.g., characterizing and/or monitoring) components of LIDAR sensor systems in a robust and scalable manner without uncertainty in optical coupling, for example inaccuracies that stem from factors including optical coupling between components in the LIDAR sensor systems.

Techniques disclosed herein include a device testing circuit for a LIDAR sensor system of a vehicle. The device testing circuit includes a first splitter optically coupled to a first connection and to a first device, the first device configured to generate a first output signal in response to receiving a first optical signal from the first connection through (e.g., by way of) the first splitter, and a second splitter optically coupled to a second connection and to a second device, the second device configured to generate a second output signal in response to receiving a second optical signal from the second connection through the second splitter. The first splitter and the second splitter are optically coupled. By using a pair of the splitters, the techniques disclosed herein can self-consistently determine performance of a device under test and/or characterize the same, without sources of inaccuracies. In addition, the techniques disclosed herein can be compatible with wafer-level measurements. The techniques can be applied to photonics chips (e.g., silicon photonics chips) or photonic integrated circuits, thereby allowing for high-volume manufacturing and/or characterizations. The techniques disclosed herein can be applied in various stages of components of the LIDAR sensor systems, for example during manufacturing, characterization, and/or operation of such devices or components thereof.

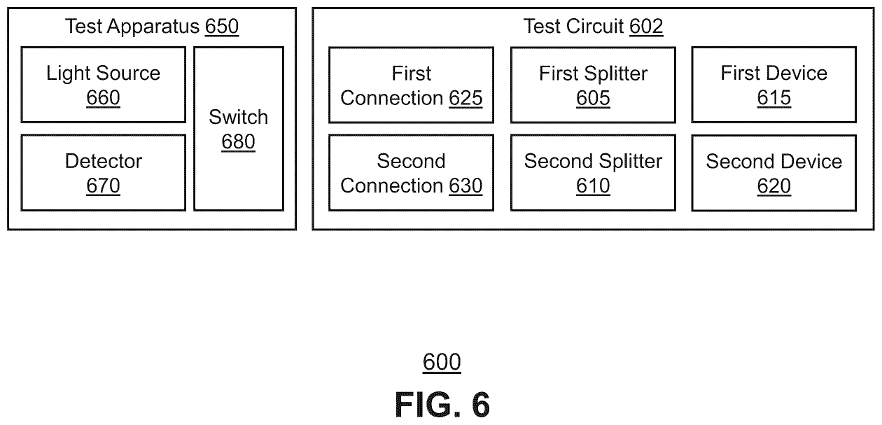

FIG. 6 depicts a block diagram illustrating an example system 600 for testing devices for a LIDAR sensor system, according to some implementations. In brief overview, the system 600 can include a test circuit 602. The test circuit 602 can include a first connection 625, a first splitter 605, a first device 615, a second connection 630, a second splitter 610, and a second device 620. In a first mode, the test circuit 602 can receive an input signal; one of the splitters (e.g., the first splitter 605) splits the input signal into a first optical signal and a first reference signal; and one of the devices (e.g., the first device 615) can receive the first optical signal and generate a first output signal in response to receiving the first optical signal while the test circuit 602 can output the first reference signal (or at least a portion thereof). This allows for a determination of an input-output response of the device under test (e.g., the first device 615). In a second mode, the test circuit 602 can receive an input signal; the other splitter (e.g., the second splitter 610) splits the input signal into a second optical signal and a second reference signal; and the other device (e.g., the second device 620) can receive the second optical signal and generate a second output signal in response to receiving the second optical signal while the test circuit 602 can output the second reference signal (or at least a portion thereof). This allows for a determination of an input-output response of the device under test (e.g., the second device 620). With the collected values, including the first reference signal, the second reference signal, the first output signal, and the second output signal, the performance of the devices (e.g., the first device 615, the second device 620) can be accurately determined.

As discussed herein, the pair of splitters (e.g., the first splitter 605, the second splitter 610) allows for accurate characterization of devices under test (e.g., the first device 615, the second device 620). Each of the pair of splitters can split a received input signal into (1) a respective optical signal, which is provided to a respective device under test to generate a respective output signal, and (2) a respective reference signal. That is, the four values (a reference signal and an optical signal from each of the pair of splitters) can be collected to use to test (e.g., characterize, monitor, etc.) the devices under test in a reliable and robust manner. For example, when the pair of splitters are identical (or substantially identical) and the devices under test are identical (or substantially identical), the performance of the devices under test can be accurately determined.

In some implementations, a test apparatus 650 can be optically coupled to the test circuit 602 to test (e.g., characterize and/or monitor) a device under test (e.g., the first device 615, the second device 620, etc.). The test apparatus 650 can include a light source 660, a detector 670, and a switch 680.

The light source 660 can include any of various light sources. The light source 660 can generate an input signal (e.g., an optical signal) to the device under test (e.g., the first device 615). The light source 660 can generate any input signal or any optical signal that can be input to the device under test to operate the device under test. The light source 660 can vary depending on the device under test. For example, the light source 660 may be a laser source that can generate a beam generated by a laser source of a LIDAR system (e.g., the laser source 504). For example, the light source 660 can generate a beam to be modulated in a modulator of a LIDAR system (e.g., the modulator 514). For example, the light source 660 can generate a beam to be amplified in an amplifier of a LIDAR system (e.g., the amplifier 520). The light source 660 can provide the input signal (e.g., an optical signal) to the device under test through the switch 680.

The switch 680 can be or include an optical switch or any of various optical switches. The switch 680 can control an optical path of the input signal generated by the light source 660. In a first mode, the switch 680 can direct the input signal to the first device 615 through the first connection 625. In a second mode, the switch 680 can direct the input signal to the second device 620 through the second connection 630. The switch 680 can control an optical path of a signal (e.g., a reference signal) that the test circuit 602 sends to the detector 670. In the first mode, the switch 680 can receive the signal from the second connection 630 of the test circuit 602 and direct to the detector 670. In the second mode, the switch 680 can receive the signal from the first connection 625 of the test circuit 602 and direct to the detector 670. In some implementations, the switch 680 may be or include a 2×2 optical switch that can control four optical paths (e.g., two input and two output paths). The switch 680 can be controlled, by an operator or a program, to switch between the first mode and the second mode.

The first connection 625 and the second connection 630 (collectively referred to as connections) are any component, chip, or structure for optical coupling. The connections can optically couple the test apparatus 650 and the test circuit 602 (e.g., the first splitter 605, the second splitter 610). The connections may be or include an optical coupler, a grating coupler, a fiber coupler, or any component, chip, or structure to communicate an optical signal between the switch 680 and the test circuit 602. In the first mode, a signal (e.g., the input signal) can be transmitted from the switch 680 to the first splitter 605 through the first connection 625, and in the second mode, a signal (e.g., the reference signal) can be transmitted from the first splitter 605 to the switch 680. For the second connection 630, in the second mode, a signal (e.g., the input signal) can be transmitted from the switch 680 to the second splitter 610 through the second connection 630, and in the first mode, a signal (e.g., the reference signal) can be transmitted from the second splitter 610 to the switch 680.

The first splitter 605 and the second splitter 610 (collectively referred to as splitters) are any component, chip, or structure to split a signal. The splitters can divide an incoming optical signal into multiple output signals. The splitters may be or include an optical splitter, a waveguide splitter, a tapered splitter, a planar lightwave circuit (PLC), a waveguide splitter, or any component, chip, or structure to split the input signal received from the switch 680 into an optical signal and a reference signal. In some implementations, the splitters may be or include a 2×2 optical splitter.

In the first mode, the first splitter 605 can provide an optical signal (e.g., a portion of the input signal; a split portion of the input signal) to the first device 615 and provide a reference signal (e.g., another portion of the input signal; a remainder of the input signal; the other portion of the input signal) to the second splitter 610. The second splitter 610 can receive the reference signal and direct the reference signal to the test apparatus 650 (e.g., to the detector 670 of the test apparatus 650). In the second mode, the second splitter 610 can provide an optical signal (e.g., a portion of the input signal; a split portion of the input signal) to the second device 620 and provide a reference signal (e.g., another portion of the input signal; a remainder of the input signal; the other portion of the input signal) to the first splitter 605. The first splitter 605 can receive the reference signal and direct the reference signal to the test apparatus 650 (e.g., the detector 670). In some implementations, the splitters can evenly divide an input signal such that an optical signal (e.g., a first split portion of the input signal) and a reference signal (e.g., a second split portion of the input signal) are identical or substantially similar to each other. For example, an intensity level of the optical signal and an intensity level of the reference signal may be identical or substantially similar to each other. This detection of a reference signal in each mode forms a “loopback” structure, which routes a signal (e.g., light) between the splitters, thereby enabling active alignment of the splitters (or in some implementations, of a fiber array unit (FAU)) to the device under test. In some implementations, the splitters may include a plurality of ports (e.g., four ports with 2×2 configuration) to communicate a signal.

The first device 615 and the second device 620 (collectively referred to as the device under test) are any device that can be tested using the test circuit 602. The device under test may be or include any component of LIDAR systems. The device under test may be or include any optical or optoelectronic device that can output an electrical or optical signal in response to receipt of an optical signal. For example, the device under test may be or include a light source (e.g., the laser source 504), a modulator (e.g., the modulator 514), an amplifier (e.g., the amplifier 520), photodetectors, free space optics components, etc. In some implementations, the first device 615 and the second device 620 may be substantially similar or identical, such as to be made according to the same specification of a manufacturing or fabrication process. In the first mode, an output signal (e.g., an optical or electrical signal) from the first device 615 can be measured. In the second mode, an output signal (e.g., an optical or electrical signal) from the second device 620 can be measured.

The detector 670 can include, for example, a photodetector, such as a photodiode. The detector 670 can detect an optical signal, and can output an electrical signal indicative of one or more parameters of the optical signal. The detector 670 can receive a reference signal from the test circuit 602 (e.g., from the first splitter 605 in the second mode, from the second splitter 610 in the first mode, etc.) through the respective connection and the switch 680. In some implementations, for example when the splitters evenly divide an input signal into an optical signal (directed to the device under test) and a reference signal (directed to the detector 670), the reference signal detected by the detector 670 can indicate the optical signal input to the device under test. In the first mode, the detector 670 can detect the reference signal that is substantially similar or identical to the optical signal input to the first device 615. In the second mode, the detector 670 can detect the reference signal that is substantially similar or identical to the optical signal input to the second device 620.

By operating the test circuit 602 in the first mode and the second mode, an output from the first device 615, an output from the second device 620, a reference signal in the first mode, and a reference signal in the second mode can be measured. Using these four measured values, an estimate of the performance of the device under test (e.g., the first device 615 and the second device 620) can be obtained in a reliable manner (e.g., assuming that the first device 615 and the second device 620 have nearly identical behaviors based on being designed as identical devices).

While the test circuit 602 may be a separate testing circuit, in some implementations, the test circuit 602 may be a part of the LIDAR sensor system (e.g., the LIDAR sensor system 500). For example, the test circuit 602 and/or the test apparatus 650 may be an integrated circuit or integrated on a chip or a wafer of the LIDAR sensor system (e.g., the LIDAR sensor system 500). In some implementations, the test apparatus 650 may be a detachable component. For example, the test apparatus 650 may be movable between a plurality of test circuits 602 to test each of the test circuits 602.

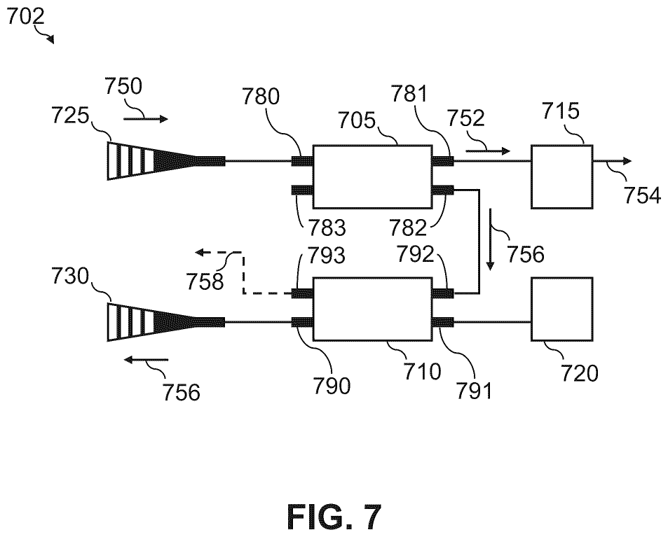

FIG. 7 depicts a schematic diagram illustrating an example test circuit 702 in a first mode for testing devices for a LIDAR sensor system, according to some implementations. The test circuit 702 may be substantially similar to and/or incorporate features of the test circuit 602.

The test circuit 702 includes a first connection 725 (e.g., the first connection 625), a second connection 730 (e.g., the second connection 630), a first splitter 705 (e.g., the first splitter 605), a second splitter 710 (e.g., the second splitter 610), a first device 715 (e.g., the first device 615), and a second device 720 (e.g., the second device 620). The first splitter 705 includes a first port 780, a second port 781, a third port 782, and a fourth port 783. The second splitter 710 includes a first port 790, a second port 791, a third port 792, and a fourth port 793.

In the first mode, the test circuit 702 can receive a first input signal 750 through the first connection 725. The first splitter 705 can receive the first input signal 750 through the first port 780 and split the first input signal 750 into a first optical signal 752 and a first reference signal 756. The first splitter 705 can direct the first optical signal 752 to the first device 715 through the second port 781, and can direct the first reference signal 756 to the second splitter 710 through the third port 782. The first device 715 can generate a first output signal 754 in response to receipt of the first optical signal 752. The second splitter 710 can receive the first reference signal 756 through the third port 792 and direct the first reference signal 756 (or at least a portion thereof) to the second connection 730 through the first port 790. The second connection 730 can receive the first reference signal 756 and can provide the first reference signal 756 to a detector (e.g., the detector 670). By operating the test circuit 702 in the first mode, the first output signal 754 and the first reference signal 756 can be measured. In some implementations, the second splitter 710 can output a first dump signal 758 through the fourth port 793. In response to receipt of the first reference signal 756 from the first splitter 705, the second splitter 710 can split the first reference signal 756 into two signals. The second splitter 710 can direct a split half of the first reference signal 756 to a detector (e.g., the detector 670) through the second connection 730 and can output the other split half (e.g., the first dump signal 758) of the first reference signal 756 through the fourth port 793.

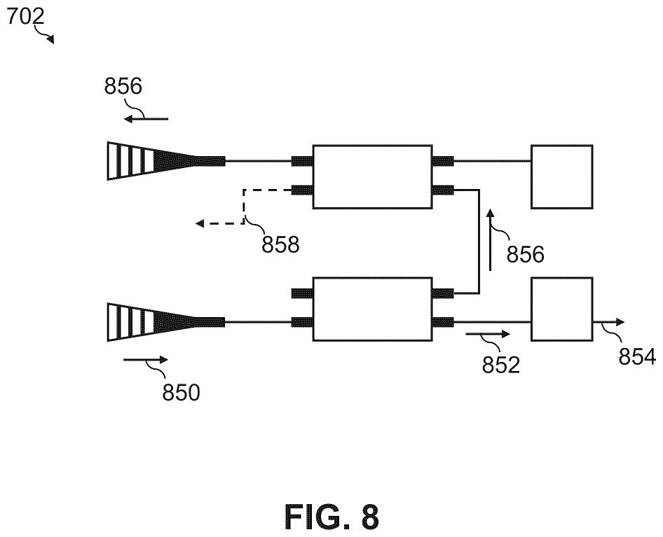

FIG. 8 depicts a schematic diagram illustrating the test circuit 702 in a second mode for testing devices for a LIDAR sensor system, according to some implementations.

In the second mode, the test circuit 702 can receive a second input signal 850 through the second connection 730. The second input signal 850 may be substantially similar to or identical to the first input signal 750. For example, an optical power (e.g., an intensity) of the second input signal 850 may be substantially similar to or identical to an optical power (e.g., an intensity) of the first input signal 750. The second splitter 710 can receive the second input signal 850 through the first port 790 and split the second input signal 850 into a second optical signal 852 and a second reference signal 856. The second optical signal 852 may be substantially similar to or identical to the first optical signal 752. For example, an optical power (e.g., an intensity) of the second optical signal 852 may be substantially similar to or identical to an optical power (e.g., an intensity) of the first optical signal 752. The second reference signal 856 may be substantially similar to or identical to the first reference signal 756. For example, an optical power (e.g., an intensity) of the second reference signal 856 may be substantially similar to or identical to an optical power (e.g., an intensity) of the first reference signal 756. The second splitter 710 can direct the second optical signal 852 to the second device 720 through the second port 791, and can direct the second reference signal 856 to the first splitter 705 through the third port 792. The second device 720 can generate a second output signal 854 in response to receipt of the second optical signal 852. The first splitter 705 can receive the second reference signal 856 through the third port 782 and direct the second reference signal 856 (or at least a portion thereof) to the first connection 725 through the first port 780. The first connection 725 can receive the second reference signal 856 and can provide the second reference signal 856 to a detector (e.g., the detector 670). By operating the test circuit 702 in the second mode, the second output signal 854 and the second reference signal 856 can be measured. In some implementations, the first splitter 705 can output a second dump signal 858 through the fourth port 783. In response to receipt of the second reference signal 856 from the second splitter 710, the first splitter 705 can split the second reference signal 856 into two signals. The first splitter 705 can direct a split half of the second reference signal 856 to a detector (e.g., the detector 670) through the first connection 725 and can output the other split half (the second dump signal 858) of the second reference signal 856 through the fourth port 783.

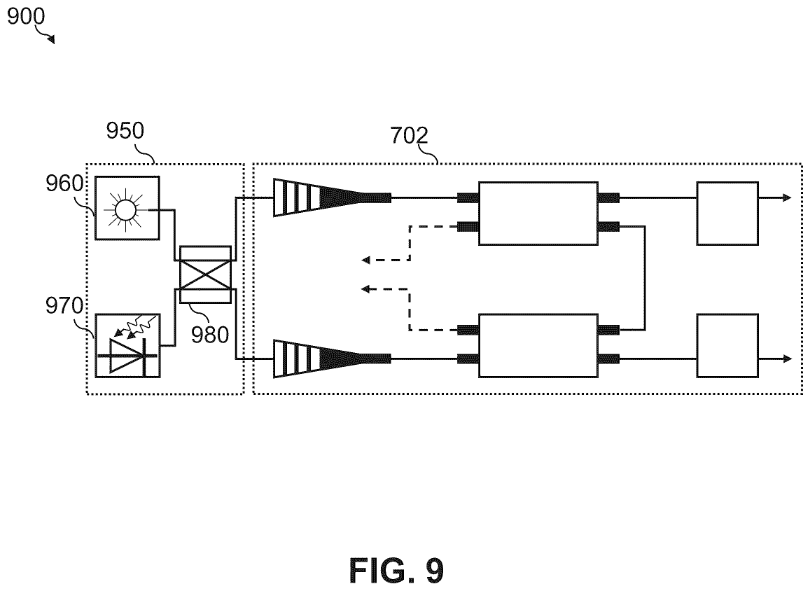

FIG. 9 depicts a schematic diagram illustrating an example system 900 for testing devices for a LIDAR sensor system, according to some implementations. The system 900 may be substantially similar to and/or incorporate features of the system 600. For example, the system 900 includes the test circuit 702, which may be substantially similar to and/or incorporate features of the test circuit 602. The system 900 includes a test apparatus 950, which may be substantially similar to and/or incorporate features of the test apparatus 650.

The test apparatus 950 can be optically coupled to the test circuit 702. For example, the test circuit 702 and/or the test apparatus 950 may be an integrated circuit or integrated on a chip or a wafer of the LIDAR sensor system (e.g., the LIDAR sensor system 500). In some implementations, the test apparatus 950 may be a detachable component. For example, the test apparatus 950 may be movable between a plurality of test circuits 7 to test each of the test circuits 7.

The test apparatus 950 includes a light source 960 (e.g., the light source 660), an optical switch 980 (e.g., the switch 680), and a detector 970 (e.g., the detector 670). In the first mode, the light source 960 can provide an input signal (e.g., the first input signal 750) to the test circuit 702 through the optical switch 980. The optical switch 980 can be configured to receive the input signal from the light source 960 and direct the input signal to the first connection 725 of the test circuit 702. The test circuit 702 can provide a reference signal (e.g., the first reference signal 756) to the test apparatus 950 in response to receipt of the input signal. In the first mode, the optical switch 980 can be configured to receive the reference signal from the second connection 730 of the test circuit 702 and can direct the reference signal to the detector 970.

In the second mode, the light source 960 can provide an input signal (e.g., the second input signal 850) to the test circuit 702 through the optical switch 980. The optical switch 980 can be configured to receive the input signal from the light source 960 and direct the input signal to the second connection 730 of the test circuit 702. The test circuit 702 can provide a reference signal (e.g., the second reference signal 856) to the test apparatus 950 in response to receipt of the input signal. In the second mode, the optical switch 980 can be configured to receive the reference signal from the first connection 725 of the test circuit 702 and can direct the reference signal to the detector 970.

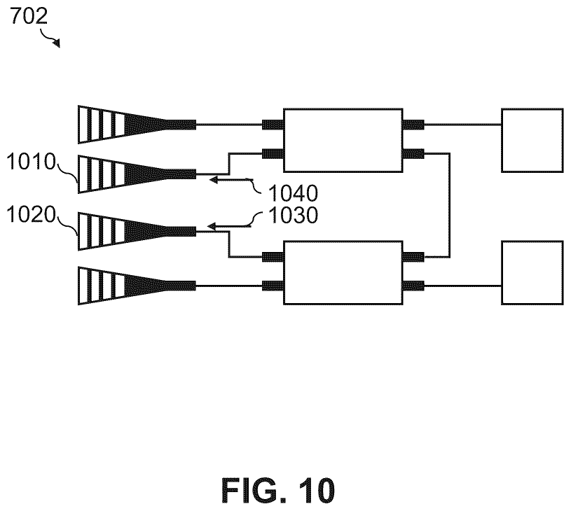

FIG. 10 depicts a schematic diagram illustrating an example test circuit 702 for testing devices for a LIDAR sensor system, according to some implementations. The test circuit 702 can additionally include a third connection 1010 and a fourth connection 1020. The third connection 1010 and the fourth connection 1020 may be substantially similar or identical to the first connection 625, the second connection 630, the first connection 725, the second connection 730, etc.

As shown, the third connection 1010 is optically coupled to the fourth port 783 of the first splitter 705, and the fourth connection 1020 is optically coupled to the fourth port 793 of the second splitter 710. In the first mode, the second splitter 710 can output a first additional signal 1030 to the fourth connection 1020 through the fourth port 793. In response to receipt of the first reference signal 756 from the first splitter 705, the second splitter 710 can split the first reference signal 756 into two signals. The second splitter 710 can direct a split half of the first reference signal 756 to a detector (e.g., the detector 670) through the second connection 730 and can output the other split half (e.g., the first additional signal 1030) of the first reference signal 756 through the fourth port 793 to the fourth connection 1020. The fourth connection 1020 can direct the first additional signal 1030 to a detector (e.g., the detector 670 or a separate detector). In the second mode, the first splitter 705 can output a second additional signal 1040 to the third connection 1010 through the fourth port 783. In response to receipt of the second reference signal 856 from the second splitter 710, the first splitter 705 can split the second reference signal 856 into two signals. The first splitter 705 can direct a split half of the second reference signal 856 to a detector (e.g., the detector 670) through the first connection 725 and can output the other split half (e.g., the second additional signal 1040) of the second reference signal 856 through the fourth port 783 to the third connection 1010. The third connection 1010 can direct the second additional signal 1040 to a detector (e.g., the detector 670 or a separate detector). The first additional signal 1030 and the second additional signal 1040 can be used to more precisely and/or accurately determine performance of the device under test (e.g., the first device 715, the second device 720) and characterize the same, by providing more information in addition to the four measured values (e.g., the first output signal 754, the second output signal 854, the first reference signal 756, and the second reference signal 856). In some implementations, the test circuit 702 shown in FIG. 10 can be in conjunction with a four-channel fiber array unit (FAU), thereby compensating for, if any, non-ideality of a 2×2 configuration.

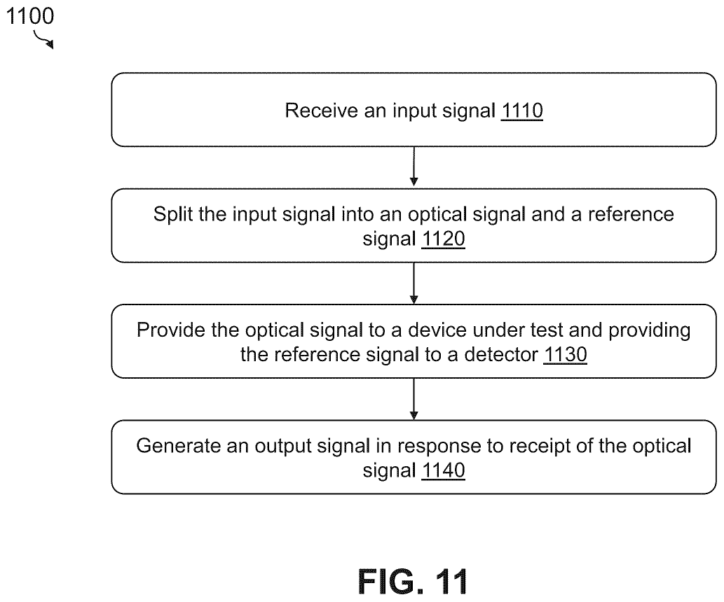

FIG. 11 depicts a flow diagram showing an example method 1100 for operating a test circuit according to some implementations. The method 1100 is merely an example and is not intended to limit the present disclosure. Accordingly, it is understood that additional operations may be provided before, during, and after the method 1100. The method 1100 can be performed with at least one of components discussed with respect to FIG. 1 to FIG. 10. For example, the method 1100 can be performed with the system 600 or a portion thereof.

At 1110, an input signal (e.g., the first input signal 750) is generated and directed to a splitter. The splitter can receive the input signal through a connection (e.g., a coupler) and/or a port. For example, the splitter can receive the input signal through an optical coupler or a grating coupler. An optical path of the input signal can be controlled using a switch, such that the input signal is directed to the splitter.

At 1120, in response to receipt of the input signal, the input signal can be split into an optical signal (e.g., the first optical signal 752) and a reference signal (e.g., the first reference signal 756). The input signal can be evenly divided into two signals, such that the optical signal and the reference signal are substantially similar or identical to each other. For example, an optical power (e.g., an intensity) of the optical signal and an optical power (e.g., an intensity) of the reference signal are identical to each other.

At 1130, in response to splitting of the input signal, the optical signal can be provided to a device under test, and the reference signal or at least a portion thereof can be provided to a detector. The reference signal can be provided to the detector through a second splitter and a second connection. The second splitter can provide the reference signal or at least a portion thereof to the detector. In some implementations, the second splitter can output a portion of the reference signal to a dump port, in response to receipt of the reference signal from the first splitter. In some implementations, the second splitter can provide a first reference signal that is a first portion of the reference signal to a first detector and provide a second reference signal that is a second portion of the reference signal to a second detector. An optical path of the reference signal can be controlled using a switch, such that the reference signal is directed to the detector.

At 1140, in response to receipt of the optical signal, an output signal (e.g., the first output signal 754) can be generated. In some implementations, an electrical output signal is generated in response to receipt of the optical signal. In some implementations, an optical output signal is generated in response to receipt of the optical signal.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

What is claimed is:

1. A method of optoelectronic device testing in manufacturing, comprising:
splitting, by one or more splitters, a first input signal into a first optical signal and a first reference optical signal, wherein the first optical signal is directed to a first optoelectronic device;
splitting, by the one or more splitters, a second input signal into a second optical signal and a second reference optical signal, wherein the second optical signal is directed to a second optoelectronic device;
generating, by the first optoelectronic device, a first output optical signal based on the first optical signal;
generating, by the second optoelectronic device, a second output optical signal based on the second optical signal; and
determining a performance of the first optoelectronic device and the second optoelectronic device based on the first output optical signal, the second output optical signal, the first reference optical signal, and the second reference optical signal.

2. The method of claim 1, comprising:
in a first mode, providing, by the one or more splitters, the first optical signal to the first optoelectronic device and the first reference optical signal to a detector; and
in a second mode, providing, by the one or more splitters, the second optical signal to the second optoelectronic device and the second reference optical signal to the detector.

3. The method of claim 1, comprising:
in a first mode, splitting the first reference optical signal into a first split reference optical signal and a second split reference optical signal;
in a second mode, splitting the second reference optical signal into a third split reference optical signal and a fourth split reference optical signal; and
determining the performance further based on the first split reference optical signal, the second split reference optical signal, the third split reference optical signal, and the fourth split reference optical signal.

4. The method of claim 1, wherein each of the first optoelectronic device and the second optoelectronic device comprises an identical type of semiconductor.

5. The method of claim 1, wherein splitting the first input signal comprises splitting the first input signal such that an optical power of the first reference optical signal is about equal to an optical power of the first optical signal.

6. The method of claim 1, wherein the first optoelectronic device and the second optoelectronic device comprise silicon photonics circuitry, planar lightwave circuity, or III-V semiconductor circuitry.

7. A method of optoelectronic device testing, comprising:
coupling a first device to a first splitter of a test circuit, the first device comprising a first semiconductor;
coupling a second device to a second splitter of the test circuit, the second device comprising a second semiconductor;
measuring a first output signal generated from the first device based on the first device receiving a first optical signal through the first splitter;
measuring a second output signal generated from the second device based on the second device receiving a second optical signal through the second splitter; and
providing the first output signal and the second output signal for testing of a performance of at least one of the first device or the second device.

8. The method of claim 7, further comprising:
measuring a first reference signal associated with the first optical signal and a second reference signal associated with the second optical signal; and
providing the first reference signal and the second reference signal for the testing of the performance of the at least one of the first device or the second device.

9. The method of claim 7, further comprising:
splitting, by the first splitter, an input optical signal into the first optical signal and a first reference signal; and
determining the performance of the at least one of the first device or the second device as a performance of the first device based on the first optical signal and the first reference signal.

10. The method of claim 7, further comprising splitting, by the first splitter, an input optical signal into the first optical signal and a first reference signal, the first optical signal having an optical power about equal to an optical power of the first reference signal.

11. The method of claim 7, wherein the first semiconductor and the second semiconductor each comprise a III-V semiconductor material.

12. The method of claim 7, wherein the first device and the second device are an identical type of optoelectronic device.

13. A method of semiconductor device testing in manufacturing, comprising:
coupling a first semiconductor device to a test apparatus through a first splitter;
outputting, by the test apparatus, a first input optical signal;
splitting, by the first splitter, the first input optical signal into a first optical signal and a first reference optical signal;
generating, by the first semiconductor device, a first output optical signal in response to the first semiconductor device receiving the first optical signal;
receiving, by the test apparatus, the first reference optical signal through a second splitter coupled with the first splitter; and
testing an input-output response of the first semiconductor device based on the first output optical signal and the first reference optical signal.

14. The method of claim 13, comprising:
coupling a second semiconductor device to the test apparatus through the second splitter;
outputting, by the test apparatus, a second input optical signal;
splitting, by the second splitter, the second input optical signal into a second optical signal and a second reference optical signal;
generating, by the second semiconductor device, based on the second optical signal;
receiving, by the test apparatus, the second reference optical signal through the first splitter; and
determining the performance of the at least one of the first semiconductor device or the second semiconductor device further based on the second output optical signal and the second reference optical signal.

15. The method of claim 13, wherein the test apparatus is coupled with the first splitter by a first optical path, and the test apparatus is coupled with the second splitter by a second optical path, the method comprising:
switching between the first optical path and the second optical path, wherein the first input optical signal is output through the first optical path, and a second input optical signal is output through the second optical path.

16. The method of claim 13, wherein the first semiconductor device and a second semiconductor device are one pair of a plurality of semiconductor device pairs, the method comprising:
moving the test apparatus between the plurality of semiconductor device pairs to determine a respective performance of each pair of the plurality of semiconductor device pairs.

17. The method of claim 13, further comprising aligning the test apparatus with the first semiconductor device to couple the test apparatus with the first semiconductor device.

18. The method of claim 13, wherein the first semiconductor device comprises a III-V semiconductor material.

19. The method of claim 13, wherein an optical power of the first reference optical signal is about equal to an optical power of the first optical signal.

20. The method of claim 13, wherein the first optoelectronic device comprises a photodetector or a free space optical coupler.
